(19) United States
(12) Patent Application Publication
(10) Pub. No.: US 2016/0061265 A1
(43) Pub. Date: Mar. 3, 2016

(54) Seal Arrangement for non-contact sealing of anti-friction bearings

(71) Applicants: Eckhard SCHOLZ, Bretten (DE); Yu Hua SCHOLZ, Bretten (DE); CBSG 3D FREIFORM GMBH, Bruchsal (DE)

(72) Inventors: Eckhard Scholz, Bretten (DE); Yu Hua Scholz, Bretten (DE)

(21) Appl. No.: 14/761,941

(22) PCT Filed: Mar. 25, 2014
(86) PCT No.: PCT/IB2014/001092

§ 371 Date: Oct. 8, 2015

(30) Foreign Application Priority Data
Feb. 13, 2013 (DE) 10 2013 002 490.0

(51) Int. Cl. F16C 33/80; F16J 15/00; F16J 15/44; F16J 15/447

(52) U.S. Cl. CPC F16C 33/805; F16J 15/447; F16J 15/002; F16J 15/443

(57) ABSTRACT

In summary, the invention relates to a seal arrangement for non-contact sealing of anti-friction bearings, in particular for sealing anti-friction bearings in conveyors, machine tools, pumps, electric motors and the like. More specifically, the invention relates to an improvement of the arrangement of non-contact fluid-collecting labyrinth seals which perform a sealing function, such that firstly no lubricating oil can escape from the anti-friction bearing side and secondly no water and contaminant can enter from the atmosphere side. The seal arrangement of the invention consists of a three-piece pre-assembled labyrinth seal, of which at least one sealing element is arranged together with the surrounding, stationary machine part and at least one sealing element is arranged on a rotatable machine part. One core advantage of this invention consists in that, if the seal arrangement according to the invention is used, a satisfactory and effective sealing result is achieved despite somewhat severe surging flooding to the sealing elements which occurs.

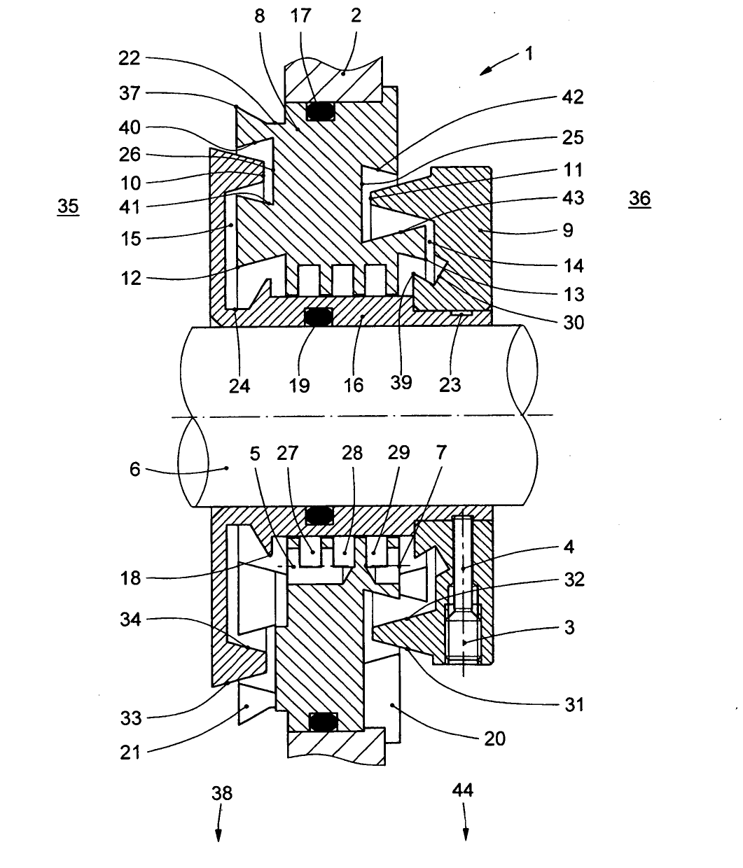

This invention relates to a seal arrangement for non-contact sealing of anti-friction bearings, in particular for sealing anti-friction bearings in conveyors, machine tools, pumps, electric motors and the like. More specifically, the invention relates to an improvement of the arrangement of non-contact fluid-collecting labyrinth seals.

Such seal arrangements of non-contact fluid-collecting labyrinth seals are known by EP 13 29 653 B1, EP 20 25 977 A2 and GB 24 31 440 A, which perform a sealing function, such that firstly no lubrication oil can escape from the anti-friction bearing side and secondly no water and contaminate can enter from atmosphere side, and which consist of at least one or more sealing elements and the elastomer sealing unit, of which at least one sealing element is arranged together with the surrounding, stationary machine part and at least one sealing element is arranged to a rotatable machine part. The core disadvantage of these seal arrangements however is that due to their design shape of the sealing gaps between the sealing elements, of which a pumping and capillary effect occurs, no satisfactory and effective sealing result is achieved, if somewhat severe surging flooding occurs to the sealing elements, or if a overfilling of the oil level occurs, even after lowering the oil level. This pumping effect can only be stopped by a time-consuming dis-assembly with a following cleaning of the seal. Furthermore the axial and radial forces from the rotatable machine part to the rotated sealing elements are transmitted by the elastomer sealing rings, so that due to the material aging and possible frequent load changes there will be a risk that the transmission of forces cannot be guaranteed permanently, especially for larger forces.

This invention is based on the task, with a simple seal arrangement to eliminate the disadvantages of types described above and to achieve a substantial improvement of such labyrinth seal arrangements, so that an effective sealing result is achieved, which was not considered possible previously for a fluid-collecting labyrinth seal.

The task is solved by the characterizing features of claim no. 1 in combination with its preamble features. The dependent claims build advantageous complete explanations of the invention.

In order to overcome the disadvantages of the type described above and to achieve a satisfactory seal despite somewhat severe surging flooding to the sealing elements, it is provided to use one three-piece pre-assembled labyrinth seal, of which one stationary sealing is tight fitted into the surrounding, stationary machine part and two rotated sealing elements are inserted non-contact in the stationary sealing element. The on the rotatable machine part fitted rotated sealing element is interlocked with the rotatable machine part and they are axially and radially fixed by means of threaded pins, cylindrical pins, undercut, drill-holes and a rotated sealing element.

The design of the seal arrangement provides a high impermeability specifically by claim no. 1 of this invention, that the guiding grooves of the stationary sealing element have conical outer and inner faces, which axially face to the thrower noses on the rotated sealing elements and widen toward the guiding groove ground; the circumferential thrower noses have conical outer and inner faces, which axially extend taperingly into the opposing guiding grooves.

The lubricating oil which is thrown around in the inside of machine adheres to the surface of the stationary machine part due to its adhesive property and then moves in the direction of the passage of the rotatable machine part. With the aid of this seal arrangement according to the invention is achieved, that lubricating oil of the bearing which adheres to the surface of the stationary machine part, moves to the running rotatable machine part or the rotated sealing element of the rotatable machine part, so that through the diverse obstacles of non-contact toothed conical faces of the thrower noses and guiding grooves, which perform seal functions such like thrower, collecting, centrifuging and diverting, the oil will be collected, diverted and discharged. So that the oil will be finally collected yet in the oil sump in stead of overwhelming the labyrinth grooves of the stationary sealing element.

In detail the lubricating oil from the bearing side will be collected by the upper guiding groove of the stationary sealing element and drained downwards to the oil sump. As the Lubricating oil falls down directly to the conical thrower nose of the rotated sealing element at the bearing side, which protrudes into the opposing conical guiding groove of the stationary sealing element, it will be thrown away from the conical thrower nose and the stationary sealing element by the centrifugal force and the said conical shape of the thrower nose. When somewhat severe surging flooding to the sealing elements occurs, the said lubricating oil is drained by the conical guiding groove of the stationary sealing element, which is stationary opposite to the thrower nose of the rotated sealing element at the bearing side, and then led to the oil sump through the drain groove of the stationary element, so that no or very little oil may get to the labyrinth groove of the stationary sealing element. When a small amount of oil enters the labyrinth groove of the stationary element, it will again be returned to the oil sump through the drain hole of the stationary sealing element. When the running machine is interrupted, the lubricating oil, which adheres on the conical inner and outer face of the thrower nose of the sealing element, moves then to the direction of the standing rotatable machine part. The lubricating oil which drips from the drip nose of the stationary machine part, will be collected by the lower guiding groove with the splash edge of the rotated sealing element and drained to the oil sump through the drain groove of the stationary sealing element. The labyrinth grooves are therefore hardly stressed.

The same functionality with the combination of stationary sealing element and the rotated sealing element on the bearing side is to be expected on the atmosphere side with the combination of the stationary element and the rotated element, because the inventive features of the bearing side combination have the similar properties of the atmosphere side combination.

At least two O-rings are provided to seal the contact surfaces between the stationary machine part and the stationary sealing element, and between the rotatable machine part and the rotated sealing element, so that a satisfactory, effective sealing function of the seal arrangement will be achieved.

A further advantage of this design is that the time-consuming dis-assembly and cleaning of the seal are spared by widening the sealing gaps which avoid the pumping and capillary effect between the sealing elements and oil leak as a result of above said. The background is that with the preamble thereof known labyrinth seals, due to their design shape of seal gaps between the sealing elements, a pumping and capillary effect will be caused. Existing somewhat severe surging flooding to the sealing elements, even by overfilling the oil level, the said seals are overstressed and the oil leak is not to be avoid due to the pumping and capillary effect, even after lowering the oil level, which can only be stopped by a time-consuming dis-assembly with a following seal cleaning.

In order to improve the axial and radial force transmission from the rotatable machine part to the rotated sealing elements concerning conventional elastomer sealing unit, a force transmission through metallic joining from the rotatable machine part to the rotated elements is achieved by that the rotated sealing element on the rotatable machine part is interlocked with the rotatable machine part, axially and radially fixed by means of threaded pins, cylindrical pins, undercut, drill-holes and a rotated sealing element.

For a simple assembly cylindrical pins combined with threaded pins are axially disposed over the undercut to facilitate the axial adjustment during the assembly on the rotatable machine part, surely that the cylindrical pins are engaged in the undercut, so that a common shift of the two rotated sealing elements is enabled.

One core advantage of this invention consists in that, if the seal arrangement according to the invention is used, a satisfactory and effective sealing result is achieved despite somewhat severe surging flooding to the sealing elements which occurs.

This invention shows advantageous, by enhancing the performance and prolonging the useful life of the seal economically, if the seal arrangement according to the invention is used despite somewhat severe surging flooding to the sealing elements which occurs, in particular, concerning the improving of the axial and radial force transmission through the elastomer sealing unit from the rotatable machine part to the rotated elements and escaping from the capillary and pumping effect caused by narrow gaps combined with the rotation effect of the rotated sealing elements.

More details of the invention appear in the attached drawing

(1) illustrates one three-piece pre-assembled labyrinth seal which locates between machine part (6) and machine part (2).

The three-piece pre-assembled labyrinth seal (1) consists of one sealing element (8) and two sealing elements (9, 16), which are inserted non-contact in the sealing element (8). The sealing element (16) is fixed with the machine part (6) axially and radially by means of threaded pins (3), cylindrical pins (4), undercut (23) and the sealing element (9). Thus a force transmission by metallic joining from the machine part (6) to the sealing elements (9, 16) is achieved.

For a simple assembly cylindrical pins (4) combined with the threaded pins (3) are axially disposed over the undercut (23) to facilitate the axial adjustment during the assembly on the rotatable machine part, surely that the cylindrical pins(4) are engaged in the undercut (23), so that a common shift of the two rotated sealing elements (9, 16) is enabled.

The design of the seal arrangement provides a high impermeability, specifically by claim no. 1 of the invention, that the guiding groove (8,26) has a conical outer face (40) and a conical inner face (41), which axially faces to the thrower nose (10,16) and widens toward the guiding groove ground; The thrower nose (10,16) has a conical outer face (33) and a conical inner face (34), which axially and taperingly extend into the opposing guiding groove (8,26); The guiding groove (8,25) has a conical outer face (42) and a conical inner face (43), axially faces to the thrower nose (9,11) and widens toward the guiding groove ground; The thrower nose (9,11) has a conical outer face (31) and a conical inner face (32), which axially and taperingly extend into the opposing guiding groove (8, 25).

Through the medium of this seal arrangement according to the invention is achieved, that lubricating oil of the bearing which adheres to the surface of the machine part (2) moves to the machine part (6) or the sealing element (16) between the machine parts (2,6), so that through the diverse obstacles of non-contact toothed conical faces (31, 32, 33, 34) of the thrower nose (10,11) and guiding grooves (25,26) which perform seal functions such like thrower, collecting, centrifuging and guiding, the oil will be collected, diverted and discharged and finally collected yet in the oil sump (38) in stead of overwhelming the labyrinth grooves (27,28) of the sealing element (8).

Bearing side (35): lubricating oil is concrete collected by the guiding groove (22) with the splash edge (37) partially and guided to the oil sump (38). Lubricating oil, which runs directly to the conical outer face (33) is thrown away from the thrower nose (10) and the sealing element (8) due to the centrifugal force and its conical shape. If somewhat severe surging flooding to the sealing elements (8, 16) caused by the lubricating oil occurs, it is drained away by the guiding groove (26) and can be led to the oil sump (38) through the drain groove (21). Subsequently, thereby no or very little oil can get into the labyrinth grooves (27, 28). When a small amount oil enters into the labyrinth grooves (27, 28), it will be again returned through the drain hole (5) to the oil sump (38). When the running machine is interrupted, the adherent lubricating oil on the conical outer face (33) and inner face (34) of the thrower nose (10) moves in the direction of the machine part (6), and the lubricating oil that drips from the drip nose(12) is collected by the guiding groove (24), stopped by the splash edge (18) to keep remained in the guiding groove (24), and led through the drain groove(21) to the oil sump (38). The labyrinth grooves (27, 28) thus are hardly stressed.

Atmosphere side (36): In detail, the water-like medium, which runs directly to the conical outer face (31) is thrown away from the thrower nose (11) and the sealing element (8) due to centrifugal force and its conical shape. If somewhat severe surging flooding to the sealing elements (8, 9) occurs, the water-like medium will be led to the drain (44) by the guiding groove (25) and the drain groove (20). Subsequently, thereby no or very little water-like medium can get into the labyrinth groove (29). If a small amount water-like medium enters into the labyrinth groove (29), it is again returned through the drain hole (7) to the drain (44). When the running machine is interrupted, the water-like medium on the conical outer face and inner face (31,32) will move in the direction of the machine part (6), and the water-like medium that drips from the drip nose (13) is collected by the guiding groove (30), stopped by the splash edge (39) to keep remained in the guiding groove (30), and led through the drain groove (20) to the drain (44). The labyrinth groove (29) thus is hardly stressed.

In order to eliminate a further disadvantage of the type described in the beginning, it is provided that the sealing gaps (14, 15) between the sealing element (8) and the sealing elements (9, 16) are extended accordingly. The achieved advantage of this invention is in particular that the negative capillary and pumping effect are eliminated, so that time-consuming dis-assembly and cleaning due to oil overfilling are spared and dis-satisfactory leak is prevented.

### REFERRING DRAWING LIST

1 Labyrinth seal
2 Machine part

### 3 Threaded pin

### 4 Cylindrical pin

5 Drain hole
6 Machine part
7 Drain hole
8 Sealing element
9 Sealing element
10 Thrower nose
11 Thrower nose
12 Drip nose
13 Drip nose

### 14 Sealing gap

### 15 Sealing gap

16 Sealing element

### 17 O-ring

18 Splash edge

### 19 O-ring

20 Drain groove
21 Drain groove
22 Guiding groove

### 23 Undercut

24 Guiding groove
25 Guiding groove
26 Guiding groove
27 Labyrinth groove
28 Labyrinth groove
29 Labyrinth groove
30 Guiding groove
31 Conical outer face
32 Conical inner face
33 Conical outer face
34 Conical inner face
35 Bearing side
36 Atmosphere side
37 Splash edge
38 Oil sump
39 Splash edge
40 Conical outer face
41 Conical inner face
42 Conical outer face
43 Conical inner face
44 Drain

1. Seal arrangement for non-contact sealing of anti-friction bearings, comprising: at least one first sealing element having at least two labyrinth grooves, at least two drain grooves and at least two drain holes attached to the surrounding, stationary machine part, wherein at least one o-ring seals the contact surface of the assembly, and at least one second sealing element attached to a rotatable machine part, wherein at least one o-ring seals the contact surface of the assembly; characterized in that:
the first circumferential guiding groove (26) of the first sealing element (8) has a conical outer face (40) and a conical inner face (41), which axially faces to the first thrower nose (10) and widens toward the guiding groove ground; the first circumferential thrower nose (10) has one conical outer face (33) and one conical inner face (34), which extends axially and taperingly into the opposing first guiding groove (26); the second circumferential guiding groove (25) of the first sealing element (8) has one conical outer face (42) and one conical inner face (43), which axially faces to the second thrower nose (11) and widens toward the guiding groove ground; the second circumferential thrower nose (11) has one conical outer face (31) and one conical inner face (32), which extends axially and taperingly into the opposing second guiding groove (25).

2. The sealing arrangement according to claim no. 1, wherein at least one third sealing element (9), in addition to having the second thrower nose (11) with the outer face (31) and the inner face (32), has also one guiding groove (30) and a splash edge (39).

3. The sealing arrangement according to claim no. 1, wherein the said second sealing element (16), in addition to having the said thrower nose (10) with the said conical outer face (33) and the said conical inner face (34), has also one guiding groove (24), one splash edge (18) and one undercut (23).

4. The sealing arrangement according to claim no. 1, wherein the said first sealing element (8)), in addition to having the said first and second guiding grooves (25, 26) with the said conical outer faces (40, 42) and the said conical inner faces (41, 43), has further also one guiding groove (22) with an axially outwards protruded splash edge (37) and downwards protruded drip noses (12, 13).

5. The sealing arrangement according to claim no. 1 to claim no. 4, wherein one three-piece pre-assembled labyrinth seal (1) consists of the said first, second and third sealing elements (8, 9, 16) that the second and third sealing elements (9, 16) are non-contact inserted in several spaces of the first sealing element (8).

6. The sealing arrangement according to one or more preceding claim, wherein the said second sealing element (16) which sits on a rotatable machine part (6), is axially and radial fixed to the rotatable machine part (6) via threaded pins (3), cylindrical pins, undercut and the said third sealing element (9).

7. The sealing arrangement according to one or more preceding claims, wherein in view of a simple assembly cylindrical pins (4) combined with the threaded pins (3) are axially disposed over the undercut (23) to facilitate the axial adjustment during the assembly, surely that the cylindrical pins(4) are engaged in the undercut (23), so that a common shift of the two rotated sealing elements (9, 16) is enabled.
